(19) United States
(12) Patent Application Publication
(10) Pub. No.: US 2026/0166559 A1
(43) Pub. Date: Jun. 18, 2026

(54) Agitator Ball Mill with Support System for Cooling the Grinding Container

(71) Applicant: NETZSCH-Feinmahltechnik GmbH, Selb (DE)

(72) Inventors: Benedikt Wenisch, Waldsassen (DE); Lars-Peter Weiland, Schönwald (DE); Matthias Kapp, Weilersbach (DE)

(21) Appl. No.: 19/422,937

(22) Filed: Dec. 17, 2025

(30) Foreign Application Priority Data
Dec. 18, 2024 (DE) 10 2024 138 556.1

(51) Int. Cl. B02C 17/18; B02C 17/04; B02C 17/16

(52) U.S. Cl. CPC B02C 17/1815; B02C 17/04; B02C 17/163

(57) ABSTRACT

An agitator ball mill with a grinding container, which is at least predominantly embodied as grinding container pipe, in which an agitator shaft and the grinding elements circulated by the agitator shaft rotate, and with a system for dissipating heat from the grinding container pipe, which system is formed by the grinding container pipe and a sleeve engaging around the grinding container pipe on the outer circumferential side, which guide a coolant between them, wherein the sleeve is pressed onto the grinding container pipe and the grinding container pipe and/or the sleeve has/have grooves, wherein the grooves, either on their own or also cooperating with one another, form coolant channels, through which a coolant can be guided between the sleeve and the grinding container pipe.

### TECHNICAL FIELD

The invention relates to an agitator ball mill with a support system for cooling the grinding container and a corresponding system.

### BACKGROUND

Conventional agitator ball bills have a vertically or horizontally arranged grinding container as essential component. Said grinding container is filled with grinding elements, which mostly consist of hard, wear-resistance materials, such as, for instance, steel, glass or ceramic. An agitator mostly ensures an intensive movement of the grinding elements in the grinding container. The grinding material is mostly pumped continuously through the grinding container as grinding material suspension, whereby the solid grinding material collides with the grinding elements in the grinding material suspension, whereby said grinding material is comminuted due to the impact and shear forces.

For the most part, corresponding grinding containers consist predominantly of a pipe, the so-called grinding container pipe, which is held and preferably also sealed by means of two flange rings. Due to the movement of the grinding elements, and also due to said impact and shear forces, the grinding material as well as the grinding elements collide with the inner circumferential surface of the grinding container pipe. The grinding container pipe is thus exposed to a strong wear attack, especially from the grinding elements. A silicon ceramic, which fulfills the necessary requirements for a corresponding wear resistance, is thus mostly used as material for the grinding container pipe. In contrast to most of the conventional ceramics, said silicon ceramic is thermally conductive to a high degree. It thus lends itself to cool the grinding container over the outer circumferential jacket surface of its grinding container pipe in order to keep the grinding container at the desired temperature.

The agitator ball mill 5 by the application, which is illustrated as FIG. 5, is a descriptive example for an agitator ball mill, as it also forms the base for the invention at hand. The grinding container 2 and the agitator shaft rotating therein, which circulates the grinding elements, can be seen well here. The jacket container, which is provided in the case of said agitator ball mill, and which engages over the grinding container 2 at a distance, can likewise be seen well. A coolant, preferably cooling water, can be brought directly into contact with the outer circumferential jacket surface of the grinding container pipe in the annular space created in this way, radially adjoining the outer circumferential jacket surface of the grinding container pipe. Cooling mats with rubber lips, through which coolant is guided in a helical manner, are often used in the prior art here. Said cooling mats mostly consist of a plastic, such as PVC, and are placed onto the outer circumference of the grinding container pipe in order to dissipate the heat in this way. However, in the case of grinding processes, for example cocoa, which run with a very pronounced generation of heat, the current cooling mats made of plastic reach their thermal limits.

In addition to the sufficient heat dissipation, an important aspect has to additionally be considered for the design of the grinding container pipe. It must be prevented under any circumstances that the grinding container pipe breaks or when a break occurs, respectively, that the grinding elements, which are partly very small, reach into the coolant circuit. A breaking of the grinding container pipe can be influenced by many factors, such as the weight and the dimensions of the grinding container pipe or also of the grinding material suspension, the grinding chamber pressure, the grinding element distribution and/or pressure surges. In order to prevent a breaking of the grinding container pipe, it is known internally to press a sleeve, mostly made of aluminum, onto the outer circumference of the grinding container pipe. On the one hand, said sleeve prevents the direct contact of the coolant with the grinding container pipe and additionally increases the strength of the grinding container pipe by means of support. Due to the fact that grinding container pipes are ground on the outside, this also does not represent a higher manufacturing effort for the grinding container pipe. For the most part, the sleeve is pressed with the grinding container pipe. The above-mentioned cooling mat can then, in turn, be attached to the outer circumference of the sleeve.

However, the press-on of a sleeve, which has already been considered, has the disadvantage that the effectiveness, with which the heat can be dissipated via the grinding container pipe, sinks perceivable hereby.

This is so because metals, which conduct heat well, such as, for example, aluminum, still conduct heat significantly worse than the special ceramics, which is generally used for the grinding container. In addition, the press-on of a sleeve as support pipe increases the wall thickness, through which the heat has to be conducted in the first place.

### SUMMARY

It is thus the object of the invention to attain a more efficient heat dissipation from the grinding container, without having to do without a sleeve for supporting the grinding container pipe.

According to the invention, this object is solved as follows.

What is proposed is an agitator ball mill with a metal container, which is predominantly embodied as grinding material pipe and in which an agitator shaft and the grinding elements circulated by said agitator shaft rotate. Said agitator ball mill comprises a system for dissipating heat from the grinding container.

In its broadest sense, the invention is characterized in that the system is formed by a sleeve (3), which engages around the grinding container pipe on the outer circumferential side and which serves for the coolant guidance, wherein the sleeve (3) is pressed to the grinding container pipe (2) and has grooves or channels, which participate in the coolant guidance.

In its preferred, narrower sense, the invention is characterized in that the system is formed by the grinding container pipe and a sleeve engaging around the grinding container pipe on the outer circumferential side, which are designed in such a way that the coolant is guided between the sleeve and the grinding container pipe. The invention is characterized in that the sleeve is pressed to the grinding container pipe and the grinding container pipe and/or the sleeve has/have grooves, wherein the grooves, either on their own or also cooperating with one another, form coolant channels, through which a coolant can be guided between the sleeve and the grinding container pipe.

A pressing of the sleeve to the grinding container pipe is understood to be a press fit of a sleeve to the grinding container pipe, which is established in that the inner diameter of the sleeve in the non-assembled state is smaller than the outer diameter of the grinding container pipe, so that the sleeve and the grinding container pipe sit one on top of the other in press fit after the assembly on the predominantly or essentially entire contact surface thereof, respectively, in such a way that more than only insignificant forces can also be transmitted from the grinding container pipe to the sleeve in the longitudinal direction of the pipe and vice versa. Initially, it is irrelevant whether the press-on takes place by means of pressing the sleeve onto the grinding container pipe by means of a press or, preferably, by means of a thermal shrink-on.

The invention in its narrower sense thus makes it possible that the highly efficiently thermally conductive special ceramics of the grinding container pipe, when such a special ceramic is used, comes into direct contact with the coolant and can thus dissipate heat particularly well to the coolant. In any event, it is no longer necessary for the heat to be dissipated to still have to pass through the supporting sleeve before it can pass to the coolant. Both significantly reduce the thermal stress on the grinding container pipe and on its content. The latter is of great importance, e.g., when grinding a grinding material, which generates high friction and which is heat-sensitive thereby, such as, e.g., when grinding chocolate or cocoa beans, respectively, with high drive power, which is necessary for this purpose.

The grinding container pipe, which is already present and/or the sleeve, which is already present, can thus generally be used for the internal coolant guidance without having to attach additional parts to the system. This contributes to the simplicity of the overall system, reduces the assembly effort and radial installation space can be saved in many situations.

As has already been specified, the coolant is preferably guided between the grinding container pipe and the sleeve. One option for this is that the grinding container pipe and the sleeve have cooperating grooves, which jointly form coolant channels. A design of this type will be selected especially when the grinding container pipe is not mechanically stressed to an extreme extent and the notching effect of grooves on the grinding container pipe thus does not play a role, but the focus is directed especially at establishing the largest possible direct contact surface between the excellently thermally conductive special ceramics and the coolant. Another option is that the sleeve has grooves on its inner circumferential surface, and thus on the surface facing the grinding container pipe, which are completed by the smooth-surface grinding container pipe, which is not provided with grooves, to form closed cooling channels. Cooling channels can thus be formed without weakening the grinding container pipe even remotely.

Either way, the sleeve, which is in fact pressed to the grinding container pipe via webs between the grooves, additionally supports the grinding container pipe in both cases, whereby a higher strength and stability of the grinding container pipe can be attained with lower material thickness. The cooling performance is thus improved even further and the risk of a break of the grinding container pipe is reduced.

A preferred embodiment is that said grooves of the grinding container pipe and/or of the sleeve have a concave and preferably semi-circular clear cross-section. The groove depth is thus preferably identical over the entire surface. On the one hand, this contributes to the easy manufacturability of the components and, on the other hand, ensures good guidance of the coolant in the coolant channels, which are created in this way, without the appearance of regions, which are less or hardly flown through.

In addition, it is particularly preferred when said grooves rotate helically on the circumferential surface. This provides for an easier, rotating coolant circulation, which reaches the entire surface, without “dead regions”, in which the coolant hardly circulates and which are thus thermally stressed more strongly.

A further conceivable embodiment is that the grinding container pipe consists of several pipes enclosing each other. At least two pipes are preferably pressed together hereby, namely generally the grinding container pipe made of special ceramics and a smooth support pipe made of aluminum. The sleeve is pressed to the outer side of the support pipe. Even though the cooling is less effective with such a design, it does guarantee that no cooling water reaches into the grinding container and that no grinding elements reach into the cooling water circuit even when a tear should appear on the grinding container pipe.

A further conceivable embodiment is that the sleeve has grooves on its outer circumferential side, wherein the grinding container pipe does not have any grooves. Even though the cooling channels are thus attached to the side facing away from the grinding container pipe, the cooling power is sufficient in some cases there due to the high thermal conductivity of the materials in order to sufficiently discharge the heat. The significant advantage of such a variation is that even in the case of a possible tear or break of the grinding container pipe, no coolant escape can take place into the grinding container in order to then force at least complex cleaning operations there and, vice versa, that an escape of grinding elements into the coolant branch or circuit can preferably also not take place.

It is particularly preferred when the sleeve at least largely consists of aluminum or an aluminum alloy. Aluminum is corrosion resistant, durable and in particular has a correspondingly high thermal conductivity in order to dissipate the heat from the inner pipe.

It is furthermore particularly preferred when the grinding container pipe consists at least largely of ceramic, preferably a silicon carbide ceramic. It is very light, but also the hardest ceramic material thereby, has a very good thermal conductivity with a low thermal expansion as well as a good resistance against acid and lyes.

A further preferred embodiment is that the sleeve has been shrunk onto the grinding container pipe. For this purpose, the sleeve is preferably initially heated, e.g., in the oven, so that it expands to the extent that it can be slid onto the grinding container pipe. A press fit is then attained in response to a cool-down of the sleeve. The clear inner diameter of the sleeve is then selected so that it is larger than the outer diameter of the grinding container pipe at a temperature, which the sleeve material withstands without impairment to the structure, and so that it is smaller than the outer diameter of the grinding container pipe at room temperature.

Further modes of operation, advantages and design options follow from the figure-supported description of the exemplary embodiment.

### BRIEF DESCRIPTION OF THE DRAWINGS

FIG. 1 shows a preferred exemplary embodiment for the system for the heat dissipation in cut three-dimensional view.

FIG. 2 shows the preferred exemplary embodiment from FIG. 1 in cut side view.

FIG. 3 shows a grinding container pipe with grooves of the preferred exemplary embodiment in side view.

FIG. 4 shows a sleeve with grooves of the preferred exemplary embodiment in cut side view.

FIG. 5 illustrates an agitator ball mill known in the prior art, as it is also the base for the current invention.

### DETAILED DESCRIPTION

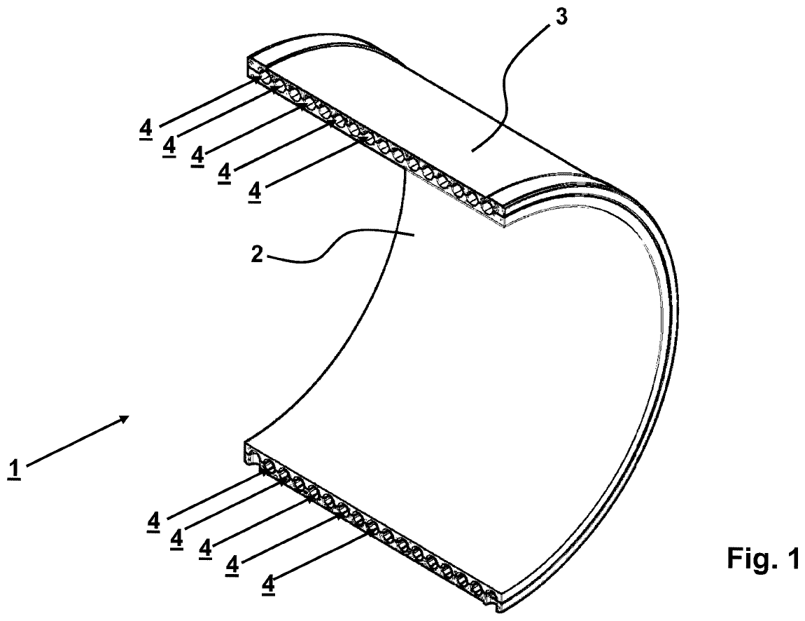

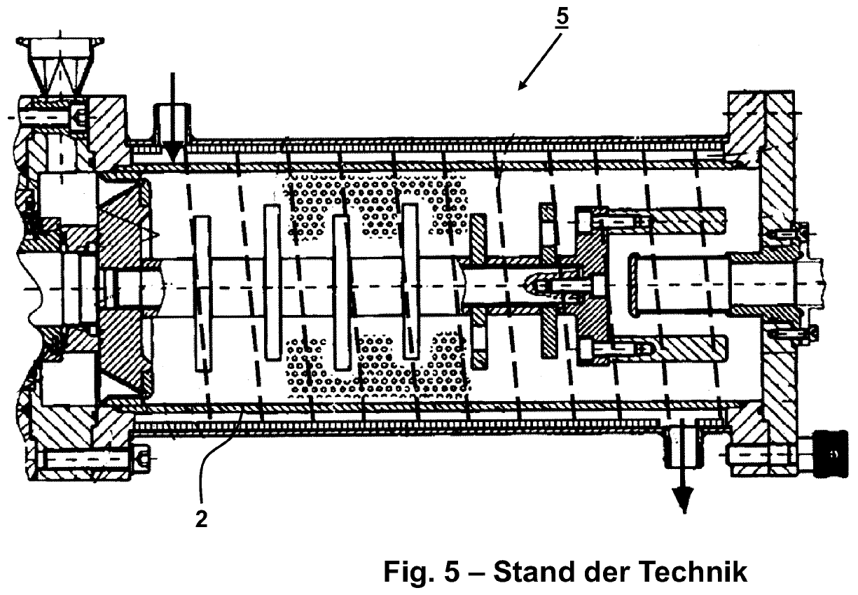

The agitator ball mill 5, which is to be mentioned as exemplary embodiment here, can be constructed exactly as illustrated in FIG. 5, only the periphery of the outer circumference of the grinding container pipe 2 is designed differently in any event according to the invention, namely in the way it is shown in FIGS. 1 to 4, when the teaching thereof is applied to FIG. 5.

For the sake of clarity, FIG. 1 to FIG. 4 thus show a preferred exemplary embodiment of the system 1 for the heat dissipation from the grinding container pipe 2, wherein the grinding container pipe 2 as well as the sleeve 3, which is pressed onto the grinding container pipe 2, have grooves here.

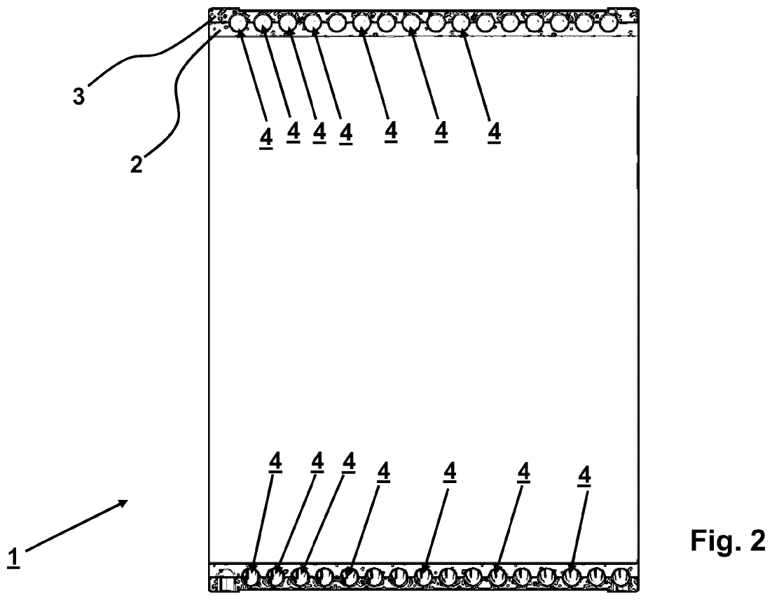

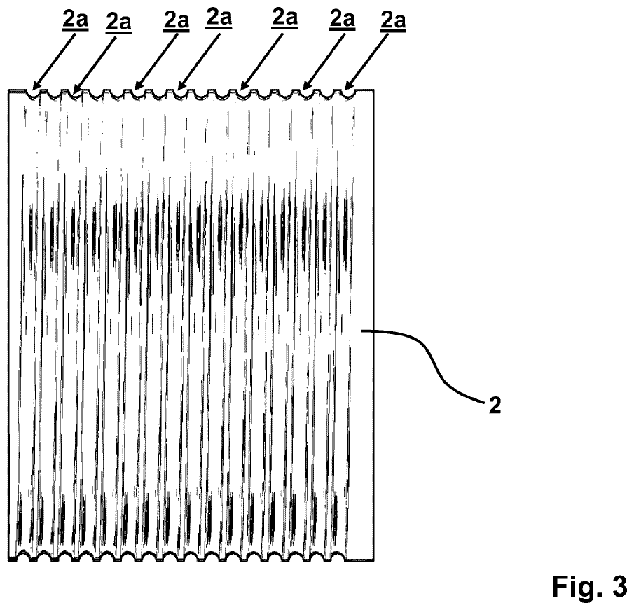

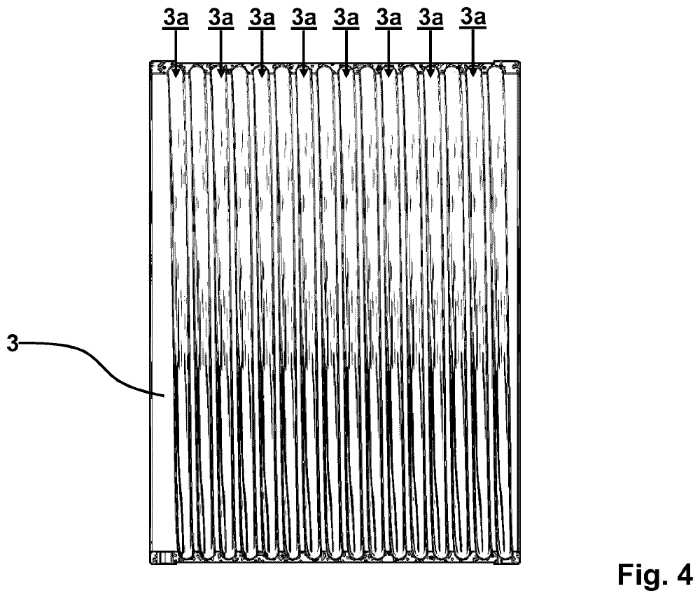

On its outer circumferential surface, the grinding container pipe 2 hereby has grooves 2a, which rotate helically (see FIG. 3). On its inner circumferential surface, the sleeve 3 has grooves 3a, which rotate helically (see FIG. 4). The grooves 2a and 3a are additionally designed and arranged so that, when the grinding container pipe 2 and the sleeve 3 are pressed together as intended, together they form coolant channels 4, which rotate helically (see FIG. 1 and FIG. 2). The grooves 2a and 3a hereby preferably have an essentially semi-circular cross-section. After the pressing of the sleeve 3 and of the grinding container pipe 2, the grooves 3a of the sleeve 3 and the grooves 2a of the grinding container pipe 2 preferably supplement one another so that helically rotating coolant channels 4 with essentially round cross-section result, through which the coolant can then flow. For this purpose, the grooves 3a of the sleeve 3 and the grooves 2a of the grinding container pipe 2 have to thus be adapted to one another in their positioning, in their diameter and their helical shape, so that they can mutually supplement one another to a rotating, hollow coil with round cross-section.

It should be mentioned hereby that even though the shown system 1 is preferably used in agitator ball mills 5, it can also be used in the case of other types of mills and machines, which require heat dissipation from an inner container.

The inner container or the grinding container pipe 2, respectively, preferably have a cylindrical shape, but other shapes are also conceivable.

The grooves 2a and 3a preferably have a semi-circular cross-section, but other shapes are also conceivable here.

Generally speaking: the helical grooves for the guidance of the coolant compel a very even cooling without dead water zones.

Generally speaking: it is important that each or essentially each of the webs, which lies between two directly adjacent grooves, enters into a press fit with its counterpart, which is assigned to it in the radial direction. In spite of the formation of the coolant-guiding grooves, a significant support effect can nonetheless be attained between the sleeve and the outer circumferential surface of the grinding container pipe, which stabilizes the grinding container pipe, preferably especially also due to the helical shape of the grooves - the much stronger webs, which are separated by the grooves, stabilize in the manner of a helical spring.

Generally speaking: an expansion and/or resistance measurement can be provided on the sleeve in order to be able to detect a tearing or breaking of the grinding container pipe before the sleeve also fails due to the excess stress imposed on it in the course of a tearing or breaking.

1. An agitator ball mill comprising a grinding container, which is at least predominantly embodied as grinding container pipe, in which an agitator shaft and the grinding elements circulated by the agitator shaft rotate, and with a system for dissipating heat from the grinding container pipe, which system is formed by or with involvement from a sleeve, which engages around the grinding container pipe on the outer circumferential side and which serves for the coolant guidance, wherein the sleeve is pressed to the grinding container pipe and has grooves or channels, which are involved in the coolant guidance.

2. The agitator ball mill, preferably according to claim 1, with a grinding container, which is at least predominantly embodied as grinding container pipe, in which an agitator shaft and the grinding elements circulated by the agitator shaft rotate, and with a system for dissipating heat from the grinding container pipe, which system is formed by the grinding container pipe and a sleeve engaging around the grinding container pipe on the outer circumferential side, which guide a coolant between them, wherein the sleeve is pressed to the grinding container pipe and the grinding container pipe and/or the sleeve has/have grooves, wherein the grooves of the sleeve, either on their own or also cooperating with the grooves of the grinding container pipe, form coolant channels, through which a coolant can be guided between the sleeve and the grinding container pipe.

3. The agitator ball mill according to claim 1, wherein the grooves have a concave and preferably semi-circular clear cross-section.

4. The agitator ball mill according to claim 1, wherein the grooves rotate helically on the circumferential surface.

5. The agitator ball mill according to claim 1, wherein on its outer circumferential surface the grinding container pipe has grooves, which cooperate with grooves on the inner circumferential surface of the sleeve in such a way that helically rotating coolant channels are formed, which have a preferably round cross-section.

6. The agitator ball mill according to claim 1, wherein the grinding container pipe consists of several pipes enclosing each other.

7. The agitator ball mill according to claim 1, wherein the sleeve has grooves on its inner circumferential surface, wherein the grinding container pipe does not have any grooves.

8. The agitator ball mill according to claim 1, wherein the sleeve has grooves on its outer circumferential surface, wherein the grinding container pipe does not have any grooves.

9. The agitator ball mill according to claim 1, wherein the sleeve at least largely consists of aluminum or an aluminum alloy.

10. The agitator ball mill according to claim 1, wherein the grinding container pipe at least largely consists of ceramic, preferably a silicon carbide ceramic.

11. The agitator ball mill according to claim 1, wherein the sleeve has been shrunk onto the grinding container pipe.

12. The agitator ball mill according to claim 1, wherein, compared to the inner diameter of the sleeve, the grinding container pipe has an outer diameter, which is larger by so much that the press fit connection between the sleeve and the grinding container pipe is not yet released even in response to exceeding the maximally permissible grinding container temperature by 20 percent.

13. A system for an agitator ball mill, comprising a grinding container pipe and a sleeve designed for the agitator ball mill with a grinding container, which is at least predominantly embodied as grinding container pipe, in which an agitator shaft and the grinding elements circulated by the agitator shaft rotate, and with a system for dissipating heat from the grinding container pipe, which system is formed by or with involvement from a sleeve, which engages around the grinding container pipe on the outer circumferential side and which serves for the coolant guidance, wherein the sleeve is pressed to the grinding container pipe and has grooves or channels, which are involved in the coolant guidance, directed at the system.

14. The agitator ball mill according to claim 2, wherein the grooves rotate helically on the circumferential surface.

15. The agitator ball mill according to claim 2, wherein on its outer circumferential surface the grinding container pipe has grooves, which cooperate with grooves on the inner circumferential surface of the sleeve in such a way that helically rotating coolant channels are formed, which have a preferably round cross-section.

16. The agitator ball mill according to claim 2, wherein the grinding container pipe consists of several pipes enclosing each other.

17. The agitator ball mill according to claim 2, wherein the sleeve has grooves on its inner circumferential surface, wherein the grinding container pipe does not have any grooves.

18. The agitator ball mill according to claim 2, wherein the sleeve has grooves on its outer circumferential surface, wherein the grinding container pipe does not have any grooves.

19. The agitator ball mill according to claim 2, wherein the sleeve at least largely consists of aluminum or an aluminum alloy.

20. The agitator ball mill according to claim 2, wherein the grinding container pipe at least largely consists of ceramic, preferably a silicon carbide ceramic.
